(19) United States
(12) Patent Application Publication
(10) Pub. No.: US 2023/0297877 A1
(43) Pub. Date: Sep. 21, 2023

(54) DOWN FUNNEL OPTIMIZATION WITH MACHINE-LEARNED LABELS

(71) Applicant: Microsoft Technology Licensing, LLC, Redmond, WA (US)

(72) Inventors: Alexandre Patry, Dublin, CA (US); Yan Zhang, Santa Clara, CA (US); Vitaly Abdrashitov, Sunnyvale, CA (US)

(21) Appl. No.: 17/698,374

(22) Filed: Mar. 18, 2022

(51) Int. Cl. G06N 20/00; G06Q 10/10; G06Q 50/00

(52) U.S. Cl. CPC G06N 20/00; G06Q 10/1053; G06Q 50/01

(57) ABSTRACT

The disclosed embodiments provide a method, apparatus, and system for training and using optimizing down funnel predictions using machine-learned labels. More particularly, rather than using a single machine-learned model to predict whether an event (e.g., whether a user will be hired for a particular job) will occur, two separately trained machine-learned models are used. The first model (called the “label model”) is used to create labels for data items (e.g., user profiles and/or other user information, job listing information, etc.) that are obtained, but where it is not known yet whether the event has occurred. These labels may then be combined with those data items and used to train the second model (called the “prediction model”) to learn how to predict whether the event will occur for a data item passed to it.

### TECHNICAL FIELD

The present disclosure generally relates to technical problems encountered in machine learning. More specifically, the present disclosure relates to down funnel optimization with machine-learned labels.

### BACKGROUND

Predictive models may be created by using machine learning algorithms to learn parameters of the models. The parameters of the models may then be applied to inputs to the models at prediction time to generate predictions. The learning of the parameters is accomplished through training of the models, which involves passing training data through a machine-learning algorithm. Typically the training data will include data items which affect the predictions, as well as labels for the data items that indicate a value of the prediction for that data item. For example, if a model is designed to predict a likelihood of an event occurring for a particular data item, training data may include information about past occurrences or non-occurrences of the event for prior data items. Each of these prior data items may have a label indicating whether the event did or did not occur for that respective data item.

While such predictive models work well when the training data and labels are fresh, they do not work as well when the training data and labels are out of date. This presents an issue for such models to accurately predict whether an event will occur when the event itself is one that is delayed from the time the data item is captured or created. In other words, they work well when the event is close in time to when the data item is captured or created, but do not work well when the event is far away in time from when the data item was captured or created.

Additionally, certain events build upon prior events having occurred. For example, if the event that is being predicted is the likelihood that a user will be hired by a particular company, that event necessarily implies that prior events would have occurred, such as the user having applied for a job at the particular company. Events that are built upon such prior events may be called down funnel events. In addition to the aforementioned lack of accuracy in machine-learned models when the event being predicted is one that is typically delayed (as is the case with job hires, as usually the job application/interview/decision process can take weeks or months to complete), the use of training data in which the result of the later event is known (e.g., the user has either been hired or rejected/turned down an offer) as training data can introduce bias into a machine-learned model, as such training data would necessarily draw only from the set of users where the prior event has occurred (e.g., the user has applied for the job), and such a training set may not be a good representation of the entirety of the population to which the prediction may be applied (e.g., users who may or may not have applied for a job).

What is needed is a solution that improves the accuracy of machine-learned models in scenarios where an event being predicted is one that is typically delayed, without introducing bias into the models.

### BRIEF DESCRIPTION OF THE DRAWINGS

Some embodiments of the technology are illustrated, by way of example and not limitation, in the figures of the accompanying drawings.

FIG. 1 is a block diagram showing the functional components of a social networking service, including a data processing module referred to herein as a search engine, for use in generating and providing search results for a search query, consistent with some embodiments of the present disclosure.

FIG. 2 is a block diagram illustrating the application server module of FIG. 1 in more detail, in accordance with an example embodiment.

FIG. 3 is a block diagram illustrating a deep learning neural network in accordance with an example embodiment.

FIG. 4 is a flow diagram illustrating a method of training multiple neural networks, in accordance with an example embodiment.

FIG. 5 is a block diagram illustrating a software architecture, in accordance with an example embodiment.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

The disclosed embodiments provide a method, apparatus, and system for training and using optimizing down funnel predictions using machine-learned labels. More particularly, rather than using a single machine-learned model to predict whether an event (e.g., whether a user will be hired for a particular job) will occur, these embodiments use two separately trained machine-learned models. The first model (called the “label model”) is used to create labels for data items (e.g., user profiles and/or other user information, job listing information, etc.) that are obtained, but where it is not known yet whether the event has occurred. These labels may then be combined with those data items and used to train the second model (called the “prediction model”) to learn how to predict whether the event will occur for a data item passed to it.

More particularly, the event being predicted may be an event that occurs later than an earlier even upon which the event is dependent. An example might be where the event is the hiring of a job applicant and the earlier event on which it is dependent is the submittal of an application for the job by the job applicant. For purposes of this disclosure, the event being predicted will be called the “later event” and the event upon which that event is dependent shall be called the “earlier event”. This terminology will be consistent regardless of whether either event has actually occurred yet. For example, the present document may refer to the prediction of the later event occurring for a data item when the occurrence of the earlier event for that data item has not occurred (or is otherwise unknown), despite the fact that neither event has actually occurred yet. Thus, the term “earlier” shall not be interpreted as requiring that the earlier event has actually occurred, merely that the event, should it occur, would occur earlier than the later event.

In an example embodiment, the label model is itself trained on training data that includes data items where the occurrence or the non-occurrence of the later event is known (e.g., the hiring process for the user for that job is complete and the user has either been hired for the job or not hired for the job, the latter occurring due to either a rejection from the employer or a rejected offer by the user). A second training set of data items may then be obtained that lacks information about whether the later event has or has not occurred. This second training set may then be fed through the label model to obtain labels for each data item in the second training set. In an example embodiment, in situations where the later event being predicted is dependent upon an earlier event having occurred (e.g., a job application being submitted), in order to reduce or eliminate any bias that might be introduced into the prediction model, only data items, in the second training set, that have an indication that the earlier event did occur are fed into the label model and have labels generated for them (e.g., the label model is only applied to data items where it is known the corresponding user applied for the job but where no information about whether they have been hired is known, and the label model is not applied to data items where it is known the corresponding user has not applied for the job). The generated labels may then be combined with the corresponding data items for which they were generated in the second training set. The other data items in the second training set would correspond to situations where the earlier event did not occur (e.g., no job application was submitted), and thus can be automatically assigned negative labels for the later event (e.g., all such users are deemed to have not been hired because they did not submit an application).

The second training set, including the generated labels, can then be used to train the prediction model. The prediction model is thus able to accurately and without bias predict a likelihood of a laterevent happening for any data item passed to it, even in situations where neither the later event nor the earlier event on which the event later depends has occurred or not occurred yet (e.g., the prediction model can predict whether a user will be hired for a job even when the user has not even applied yet and it is not known if the user even will apply).

### Description

In an example embodiment, two separate machine-learned models are trained. The first machine-learned model, termed the “label model,” is designed to generate predictions that are to be used to label training data that will be used to train the second machine-learned model, termed the “prediction model.” This solution may be used in situations where the event being predicted by the prediction model is one which is typically delayed.

It should be noted that embodiments are described herein in the context of predicting job hires, namely predicting whether a particular user will be hired for a particular job. Nevertheless, one of ordinary skill in the art will recognize that the solution may be used in any number of different predictions and should not be limited to only use in predicting job hires or even use in predicting events in the hiring process.

The rise of the Internet has occasioned two disparate yet related phenomena: the increase in the presence of online networks, such as social networking services, with their corresponding user profiles visible to large numbers of people, and the increase in the use of these online networking services to provide content. An example of such content is job listing content. Here, job listings are posted to a social networking service, and these job listings are presented to users of the social networking service, either as results of job searches performed by the users in the social networking service or as unsolicited content presented to users in various other channels of the social networking service.

Whether a particular user will ultimately be hired for a particular job can be a useful signal in a determination of whether to display a job listing for the particular job to that particular user. In some contexts, for example, job listings under consideration for display to a particular user may be ranked by a ranking model based on estimated relevance of the corresponding job listing to the particular user, and the likelihood of the user getting hired for the job can be a valuable signal in determining such relevance.

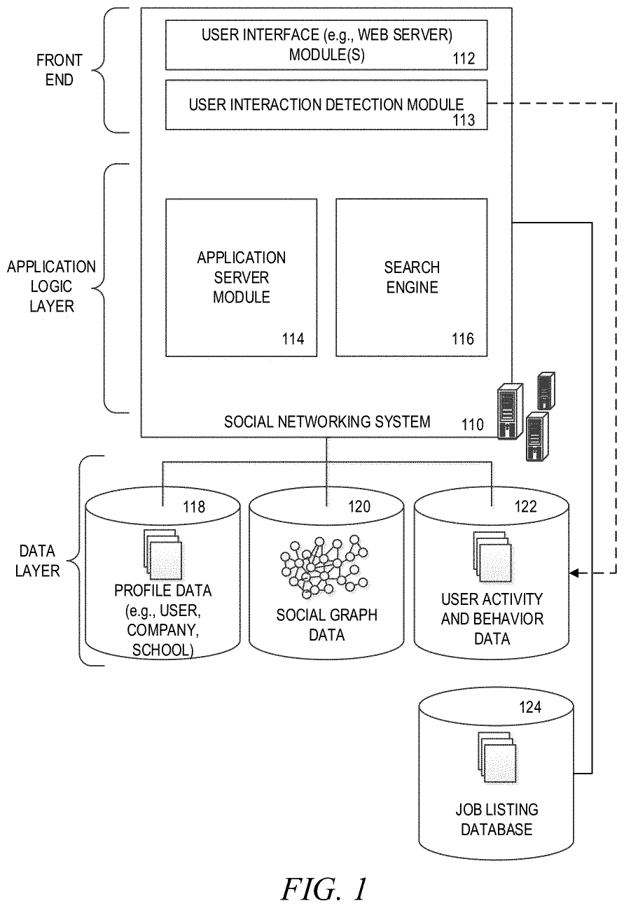

FIG. 1 is a block diagram showing the functional components of a social networking service, including a data processing module referred to herein as a search engine, for use in generating and providing search results for a search query, consistent with some embodiments of the present disclosure.

As shown in FIG. 1, a front end may comprise a user interface module 112, which receives requests from various client computing devices and communicates appropriate responses to the requesting client devices. For example, the user interface module(s) 112 may receive requests in the form of Hypertext Transfer Protocol (HTTP) requests or other web-based Application Program Interface (API) requests. In addition, a user interaction detection module 113 may be provided to detect various interactions that users have with different applications, services, and content presented. As shown in FIG. 1, upon detecting a particular interaction, the user interaction detection module 113 logs the interaction, including the type of interaction and any metadata relating to the interaction, in a user activity and behavior database 122.

An application logic layer may include one or more various application server modules 114, which, in conjunction with the user interface module(s) 112, generate various user interfaces (e.g., web pages) with data retrieved from various data sources in a data layer. In some embodiments, individual application server modules 114 are used to implement the functionality associated with various applications and/or services provided by the social networking service.

As shown in FIG. 1, the data layer may include several databases, such as a profile database 118 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 118. Similarly, when a representative of an organization initially registers the organization with the social networking service, the representative may be prompted to provide certain information about the organization. This information may be stored, for example, in the profile database 118, or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 120.

As users interact with the various applications, services, and content made available via the social networking service, the users' interactions and behavior (e.g., content viewed, links or buttons selected, messages responded to, etc.) may be tracked, and information concerning the users' activities and behavior may be logged or stored, for example, as indicated in FIG. 1, by the user activity and behavior database 122. This logged activity information may then be used by the search engine 116 to determine search results for a search query.

Although not shown, in some embodiments, the social networking system 110 provides an API module via which applications and services can access various data and services provided or maintained by the social networking service. For example, using an API, an application may be able to request and/or receive one or more recommendations. Such applications may be browser-based applications or may be operating system-specific. In particular, some applications may reside and execute (at least partially) on one or more mobile devices (e.g., phone or tablet computing devices) with a mobile operating system. Furthermore, while in many cases the applications or services that leverage the API may be applications and services that are developed and maintained by the entity operating the social networking service, nothing other than data privacy concerns prevents the API from being provided to the public or to certain third parties under special arrangements, thereby making the navigation recommendations available to third-party applications and services.

Although the search engine 116 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 116 facilitates the indexing and searching for content within the social networking service, such as the indexing and searching for data or information contained in the data layer, such as profile data (stored, e.g., in the profile database 118), social graph data (stored, e.g., in the social graph database 120), and user activity and behavior data (stored, e.g., in the user activity and behavior database 122). The search engine 116 may collect, parse, and/or store data in an index or other similar structure to facilitate the identification and retrieval of information in response to received queries for information. This may include, but is not limited to, forward search indexes, inverted indexes, N-gram indexes, and so on.

As described above, example embodiments may be utilized for ranking and/or selection of job listings. These job listings may be posted by job posters (entities that perform the posting, such as businesses) and stored in job listing database 124.

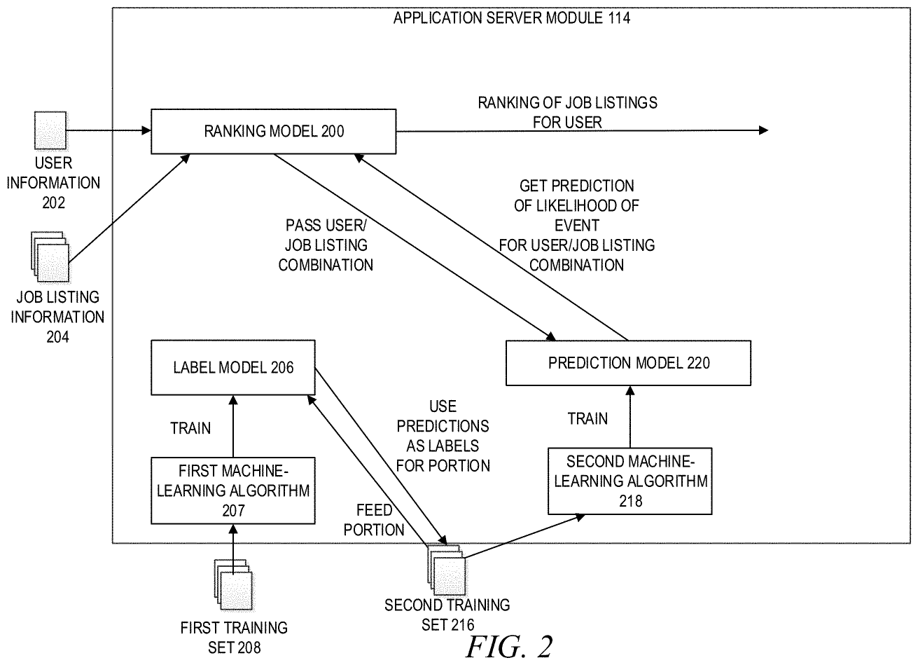

FIG. 2 is a block diagram illustrating the application server module 114 of FIG. 1 in more detail, in accordance with an example embodiment. While in many embodiments the application server module 114 will contain many subcomponents used to perform various different actions within the social networking system 110, in FIG. 2 only those components that are relevant to the present disclosure are depicted.

Here the application server module 114 is designed to display one or more job listings to a user. As mentioned above, this displaying of job listings can occur in a variety of different channels and a variety of different ways, but generally speaking, a ranking model 200 takes as input user information 202 (e.g., user profile, usage information) about the user, as well as job listing information 204 about a number of different job listings being considered for display to the user, and then ranks the different job listings based on estimated relevance of the job listings to the user. The highest ranking job listings may then be presented to the user. The details of the calculation of relevance and the operation of the ranking model 200 itself may take many forms and is outside of the scope of this disclosure. For purposes of the present document, as part of the relevance calculation, the ranking model 200 may utilize a signal indicating the likelihood of the user being hired for the jobs pertaining to the different job listings. For example, even though the ranking model 200 may determine that a particular user would be highly interested in a particular job listing, if that user is extremely unlikely to get hired for the corresponding job, then the ranking model 200 may rank that particular job listing lower than another job listing that they may hold only moderate interest in but which the user is likelier to get hired for.

As described earlier, a technical issue arises, however, in calculation of the signal indicating the likelihood of the user being hired for the jobs pertaining to the different job listings. This technical issue is that the accuracy of a single machine-learned model trained to predict such a likelihood is low because the event being predicted (whether a user is hired) is one that is delayed from when user information 202 and job listing information 204 are captured and/or obtained, and the event is even one that is dependent upon an earlier intermediate event occurring (such as the user actually applying for the job).

More particularly, the lack of accuracy in such machine-learned models is due to the fact that the training data used to train them is inherently out-of-date when it is used, as it can often take weeks or months for a hiring candidate to make their way through the hiring process and an actual hire (or rejection) to occur. This problem may be further compounded by virtue of the fact that such data, even when available, may be sparse. For example, while a social networking service may present job listings to a user and may offer the ability for the user to apply for the corresponding jobs through the social networking service, it may or may not have insight into whether the user was actually ever hired for the job, as applicant tracking systems (ATSs) of companies may not be integrated into the social networking service or may not even be in communication with it. In other words, while there may be a large amount of training data available from the fact that many job listings may have been presented in the past to previous users, labels for this training data may be rare for delayed events such as confirmed hire events because of the large gap in time between when the job listing would have been presented to a previous user and when the previous user would actually have been hired for the job corresponding to the job listing, and may be rarer still since confirmed hire events may not even be communicated to the social networking service for certain job listings.

A biasing problem can also occur due to the fact that training data that does have labels for a later event inherently are data items in which an earlier event on which the later event to be predicted is dependent has definitely occurred, and the population of users that have applied for a job may not be representative of the population of users that may be shown a job listing for the job by the system. In other words, if the only labelled training data is data in which a user has been hired, this inherently means that the labelled training data only includes data from users who have applied to a job, and thus using such data to train a model to predict whether users who have not applied for a job yet (and may never do so) may result in that model being inaccurate for what potentially is a different distribution of users than the ones who have definitely applied for a job.

To remedy these technical problems, two machine-learned models are used. First, a label model 206 is trained by a first machine-learning algorithm 207 to generate labels. More particularly, a first training set 208 of training data is fed to the first machine-learning algorithm 207. The first training set 208 may include only training data in which the occurrence of the later event is known. In this example, this means the first training set 208 includes only training data where it is known that the user ultimately did or did not get hired for the job. This training data may be obtained by referencing past instances where users were shown job listings, and thus may include prior user information (e.g., user profile, usage information) about the user, as well as prior job listing information about a number of different job listings being considered for display to the user, obtained from the profile database 118, social graph database 120, user activity and behavior database 122, and/or job listing database 124.

It should be noted that it should be noted that throughout this document the concept of a knowledge of whether or not an event “occurred” shall be interpreted broadly to include situations where the knowledge is not necessarily 100% known. In one example, an event is known to have occurred if a data set has been created or modified in such a way that indicates that the event did or did not occur, and thus the system may be relying on other systems determining accurately whether the event did or did not occur. In another example, the system may go further and simply assume, under some circumstances, that an event did or did not occur, despite not strictly knowing for sure that the event did or did not occur. Thus, for purposes of this document, the concept of an occurrence of an event being known shall be interpreted broadly to cover not only cases where it is known for sure that the event occurred but also cases where it is assumed that the event occurred.

Once the label model 206 is trained, a portion of a second training set 216 of training data is fed to the label model 206, which generates a label for each piece of training data in the portion. The second training set 216 may include only training data in which the occurrence of the later event is unknown. In this example, this means the second training set 216 includes only training data where it is not known whether the user ultimately did or did not get hired for the job. The portion of the second training set 216 may include only training data where it is known that an earlier event on which the later event is dependent did, in fact, occur. In this example, this means the portion includes only training data where it is known that the user did, in fact, apply for the corresponding job (although where it is not known whether the user actually did get hired for the corresponding job).

As with the first training set 208, the second training set 216 may be obtained by referencing past instances where users were displayed job listings, and thus may include prior user information (e.g., user profile, usage information) about the user, as well as prior job listing information about a number of different job listings being considered for display to the user, obtained from the profile database 118, social graph database 120, user activity and behavior database 122, and/or job listing database 124.

The first training set 208, since it relies upon the second event either having or not having occurred, can be created once the second event is known (or at least assumed) to have or have not occurred. The second training set 216, on the other hand, can be created at any stage, as it does not strictly require either the first event or the second event to have occurred, although the techniques described herein using the label model 206 do necessitate that at the very least the first event to have occurred (or assumed to have occurred) for the portion of the second training set 216 for which the label model 206 will generate labels.

The label model 206 is only used to generate labels for each piece of training data in the portion where the first event is known (or assumed) to have occurred (in this case, that the corresponding user actually applied for the corresponding job). Optionally, labels may be added to the training data in the second training set 216 that are not also in the portion using a separate technique, which in this case may be automatically labelling such training data with negative labels, indicating that a hire did not occur.

The generated labels may be added to the portion of the second training set 216. The second training set 216 may then be input to a second machine learning algorithm 218 to train a prediction model 220 to predict whether the event will occur for a user. The result is that rather than the prediction model 220 being trained based on sparse and delayed training data, that may be lacking labels for a large number of its training data due to the delay inherent in the event and/or the sparseness caused by the lack of integration with ATSs, the prediction model 220 is instead trained using training data that has the labels themselves predicted by a separate model (the label model 206).

It should be noted that while FIG. 2 depicts the case where the ranking model 200 and the prediction model 220 are separate models, in some example embodiments they are part of the same model. In other words, in some example embodiments, the prediction model 220 is part of the ranking model 200 itself.

The prediction model 220 may then be used to evaluate any given user/job listing combination being considered by the ranking model 200 to produce a signal indicative of the likelihood that the user will be hired for the job corresponding to the job listing. As described above, this signal is useful in the ranking model 200 deciding whether to display the job listing to the user.

The labels generated by the label model 206 are predictions of whether a corresponding user will be hired for a corresponding job, but they are only generated for data that will be used to train the prediction model 220 and are not used directly by the ranking model 200 in determining whether to display a particular job listing to a particular user.

The following is a chart showing training sets in accordance with an example embodiment:

### First Training Set:

| User | First Event | Second Event |
|---|---|---|
| User A | Y | Y |
| User B | Y | N |
| User C | N | N |
| User D | Y | N |
| User E | Y | Y |

As can be seen, the first data set includes only data items for users where the outcome of both the first event and the second event is known. Furthermore, since the second event is dependent on the first event, whenever the first event is known to have not occurred (depicted by “N”), the second event is also known to have not occurred (e.g., if the user never applied, it can be assumed that the user was never hired for the job). This first training set therefore has both positive and negative samples and can be used to train the label model.

### Second Training Set:

| User | First Event | Second Event |
|---|---|---|
| User L | Y | Unknown |
| User M | Y | Unknown |
| User N | N | Unknown |
| User O | Unknown | Unknown |
| User P | Unknown | Unknown |

As can be seen, the second data set includes only data items for users where the outcome for the second event is unknown (depicted by “unknown”). Further, the second data set includes data items for users where the outcome for the first event is known and is known to have occurred (depicted by “Y”), data items for users where the outcome for the first event is known and known to have not occurred (depicted by “N”), and data items for users where the outcome for the first event is unknown (depicted by “unknown). The portion of the second data set to which the label model is then used to apply labels would comprise only that portion where the outcome for the first event is known and is known to have occurred (in this example, the data items for User L and User M). Thus, the output of the label may be combined with the second training set to result in the following:

### Second Training Set:

| User | First Event | Second Event |
|---|---|---|
| User L | Y | Label: Y |
| User M | Y | Label: N |
| User N | N | Unknown |
| User O | Unknown | Unknown |
| User P | Unknown | Unknown |

Here, the label model has predicted that User L will be hired, while User M will not, and those predictions have been added as labels to the second training set. As described above, optionally the other data items in the second training set can have labels added via other techniques. For example, the data item for User N can have a label automatically added as “N” since the second event is dependent on the first event having occurred, and for user N the first event did not occur. Likewise, the data item for Users O and P can have labels added via some other technique, such that if a preset period of time has passed without a notification of the second event occurring, it may be presumed that the second event did not occur (without assuming one way or the other whether the first event did). Thus, the second training set may eventually look like the following:

### Second Training Set:

| User | First Event | Second Event |
|---|---|---|
| User L | Y | Label: Y |
| User M | Y | Label: N |
| User N | N | Label: N |
| User O | Unknown | Label: Y |
| User P | Unknown | Label: N |

The second training set can then be used to train the prediction model. It should be noted that the first machine learning algorithm 207 and the second machine learning algorithm 218 can be completely different types of machine learning algorithms, despite them both essentially predicting the same thing (whether a particular user will be hired for a particular job). This allows the first machine learning algorithm 207 to be selected to optimize for the fact that the label model 206 is only going to be applied to a particular subset of users (i.e., only those that applied for jobs), while the second machine learning algorithm 218 may be selected to optimize for the fact that the prediction model 220 is going to be applied to all users.

In an example embodiment, the first machine learning algorithm 207 is a pointwise deep learning neural network while the second machine learning algorithm 218 is a listwise deep learning neural network. As will be described in more detail below, neural networks learn values for various parameters by iterating different values for a particular piece of training data and then test the values by applying a loss function to see if the loss function is minimized. Pointwise learning looks at a single document at a time in the loss function, taking a single document and training a classifier/regressor on it to make its prediction. Listwise learning looks at an entire list of documents and attempts to derive an optimal ordering for the entire list.

It should be noted that while FIG. 2 depicts an example embodiment with two models (label model 206 and prediction model 220), because the event being predicted is dependent on one other event, in other example embodiments, more than two models may be utilized. More particularly, in cases where the event being predicted is dependent on multiple other events, there may be multiple label models, one for each of the dependent events.

Take, for example, in the case described above where the event being predicted by the prediction model 220 is a confirmed hire and the event that a confirmed hire is dependent upon is a job application being submitted, suppose that rather than trying to predict a confirmed hire event, the event being predicted is one that is subsequent to the confirmed hire event and dependent upon it, such a one-year work anniversary (the user having been working at the company for at least a year). As long as it is possible to track such events, it might be valuable to predict such subsequent events, especially for jobs where significant training is needed once a user is hired and the user may not become profitable for the company until working there at least a year. In such an instance, there may be two label models. The first label model may predict labels to assign to training data of the second label model, and the second label model may predict labels to assign to training data of the prediction model.

Furthermore, as described earlier, there are numerous possible use cases for the present solution, different than merely predicting confirmed hires when such an event is dependent on an application event.

One such other use case is digital advertisements. Digital advertisements, especially for products and/or services, often have multiple events, with later ones being dependent on earlier ones having occurred. For example, while it is common for digital advertisers to measure the number of “clicks” on a digital advertisement as a measure of success, in reality what is ultimately important to the underlying companies that are selling the products and/or services is “conversions” (namely the turning of those clicks into actual sales). A click on a digital advertisement may send the viewer to a website where the company sells a product or service, and then the user may purchase the product or service, at which point it becomes a conversion. Thus, the present solution may be applied to such a case, with the earlier event being a click on a digital advertisement and the later event that is dependent on the earlier event being the conversion.

Another such use case would be lead generation, which is similar to digital advertisements but rather than a digital advertisement click being the first event, a response to a sales communication from a salesperson may be the first event. In other words, a salesman may wish to predict the likelihood of a potential sales lead turning into a converted sale, and such an event may be predicated on the potential sales lead actually responding to a communication (such as an email or phone call) from the salesperson.

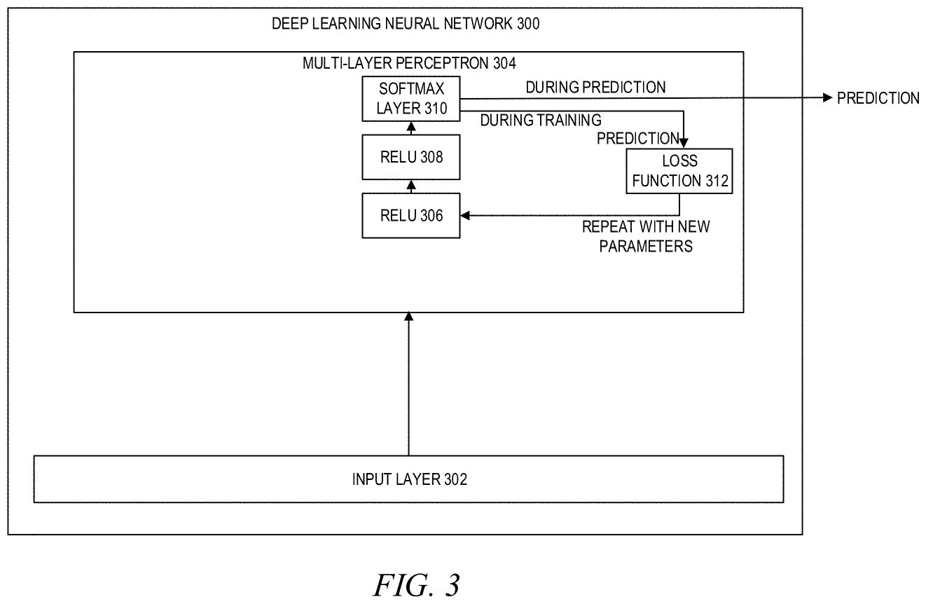

FIG. 3 is a block diagram illustrating a deep learning neural network 300, in accordance with an example embodiment. This example may be utilized for either the first machine-learning algorithm 207 or the second machine learning algorithm 218, as the difference between a listwise deep learning neural network and a pointwise deep learning neural network exists only in the loss function, and thus this difference would not be reflected in this figure.

The deep learning neural network 300 includes an input layer 302 that obtains input data (either training data during a training phase or non-training data during a prediction phase). The input data may include user and/or job listing-related data. Data used in machine-learned models is typically referred to as “features” or “feature data.” In some example embodiments, this input data may be utilized as features in the manner in which it is retrieved; for example, fields of a user profile may be extracted and used without transformation. In other instances, however, one of more aspects of the input data may be transformed or recalculated to the features. For example, a particular field in a user profile may need to be reformatted, transformed into a different data type, or normalized to a different scale, to be used as a feature. Additionally, in some instances, some input data may be used to calculate the feature, such as where the feature is an output of a mathematical operation (such as a sum, average, or the like).

Regardless, the output of the input layer 302 may include a single vector for each data point in the training data, with a data point being a combination of the input related to a single event. In the case of job listings, the single vector may include a combination of the user-related data and the job listing-related data for a single user/job listing combination.

It should be noted that the term “vector” in this context shall be interpreted using the definition of how the term is used in computer software contexts, namely that it is a 1-dimensional array of values, rather than how the term is used in mathematical contexts, namely a line with a direction.

During a training phase of the deep learning neural network 300, the vectors will include the corresponding labels from the training data. In the case where the deep learning neural network 300 is the first machine learning algorithm 207, the corresponding labels (used as input) are obtained from actual past instances where a user either was hired for a job or not hired for the job after having applied. In the case where the deep learning neural network 300 is the second machine learning algorithm 218, the labels are actually at least partially labels predicted by the output of the label model 206.

The vectors are then passed through a multi-layer perceptron 304, including a plurality of Rectifier Linear Units (ReLUs) 306, 308. A ReLU is a type of activation function that is linear for all positive values and zero for all negative values. An activation function helps a machine-learned model account for interaction effects (one variable affecting a prediction differently depending upon the value for another value) and non-linear effects. It should be noted that while FIG. 3 depicts two ReLUs 306, 308 in the multi-layer perceptron 304, other numbers of ReLUs are possible and nothing in this document shall be interpreted as limiting the number to exactly two.

The output of the ReLUs 306, 308 is a vector that is passed to a softmax layer 310 to output a prediction.

While this outputted prediction can simply then be used by the social networking service for various features when it is output during prediction-time, if it is output during the training of the multi-layer perceptron deep learning neural network 300, then a loss function 312 may be evaluated. The loss function evaluates function based on the outputted prediction and the label for the corresponding piece of training data, essentially determining if the multi-layer perceptron 304 was accurate enough in its prediction. If the loss function is not minimized, then the training repeats the passing of the dense vector through the ReLUs 306, 308 and softmax layer 310 altering parameters of the multi-layer perceptron deep learning neural network 300. Thus the ReLUs 306, 308 are repetitively iterated through for each dense vector until the loss function is minimized, at which point those parameters are said to have been learned. Each successive dense vector received during training also has a corresponding label that can be used for such iterative learning. The result is that the ReLUs 306, 308 are trained to optimize the parameters for the entirety of the training data, and these optimized parameters are then what may be used at prediction time to predict event probabilities for user/job listing combinations in which the event probability is unknown.

Thus, the ReLUs 306, 308 are retrained with each piece of training data fed to the deep learning neural network 300 during training, and it is also possible for a “trained” deep learning neural network 300 to be retrained at a later point by feeding additional training data into it during a subsequent training phase.

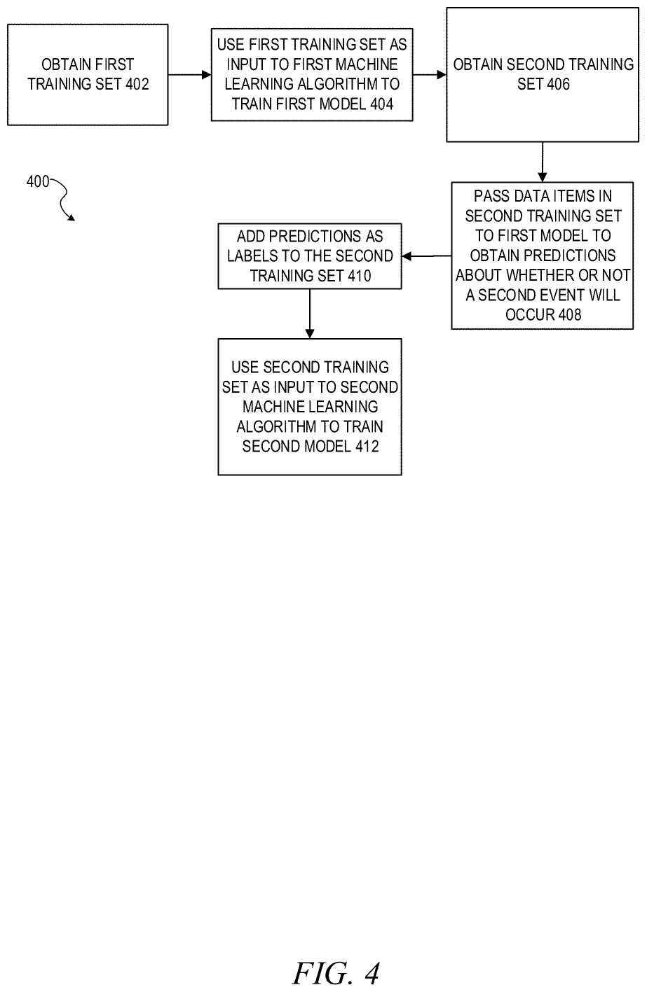

FIG. 4 is a flow diagram illustrating a method 400 of training multiple neural networks, in accordance with an example embodiment. At operation 402, a first training set is obtained. The first training set contains one or more data items having information about whether a first (earlier) event occurred and whether a second (later) event dependent on the first event occurred. At operation 404, the first training set is used as input to a first machine learning algorithm to train a first model to predict whether the second event will occur for a data item passed as input to the first model.

At operation 406, a second training set is obtained. The second training set contains one or more data items having information about whether a first event occurred but not having data about whether the second event occurred. At operation 408, the data items in the second training set are input to the first model to obtain one or more predictions as to whether the second event will occur. At operation 410, the predictions are added as labels to the second training set.

At operation 412, the second training set is used as input to a second machine learning algorithm to train a second model to predict whether the second event will occur for a data item passed as input to the second model.

While not pictured in FIG. 4, once the second model has been trained, it may be used to predict the likelihood of the second event happening for any data item passed to it. For example, the data item may be the combination of user information for a first user and job listing information for a job listing being considered for display to the first user. The user information and the job listing information may be passed to the second model to predict the likelihood of the first user being a confirmed hire for the job corresponding to the job listing, assuming the job listing is displayed to the user. A ranking model may then use this predicted likelihood to determine whether to display the job listing to the first user (such as by ranking this predicted likelihood against predicted likelihoods calculated for different job listings in combination with the first user).

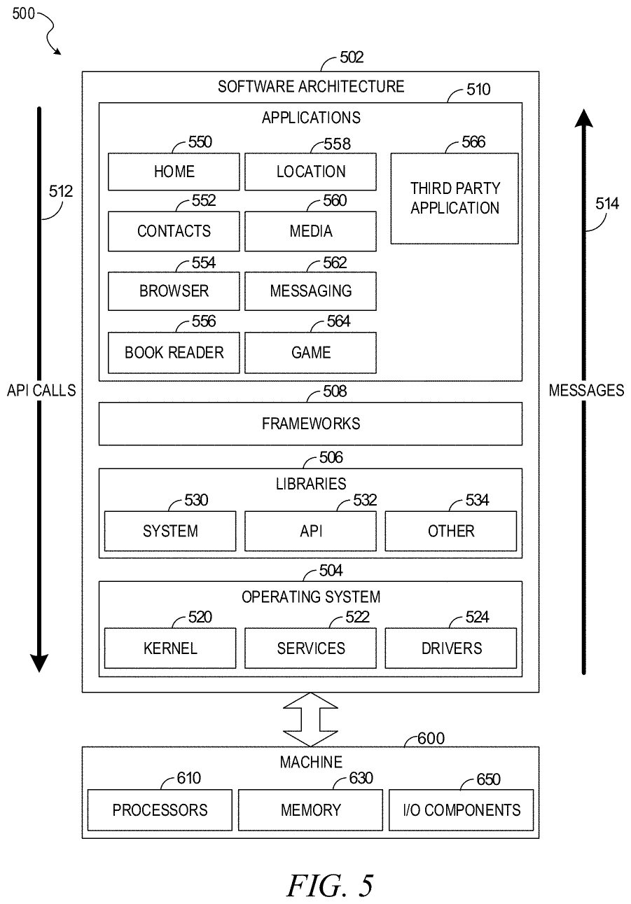

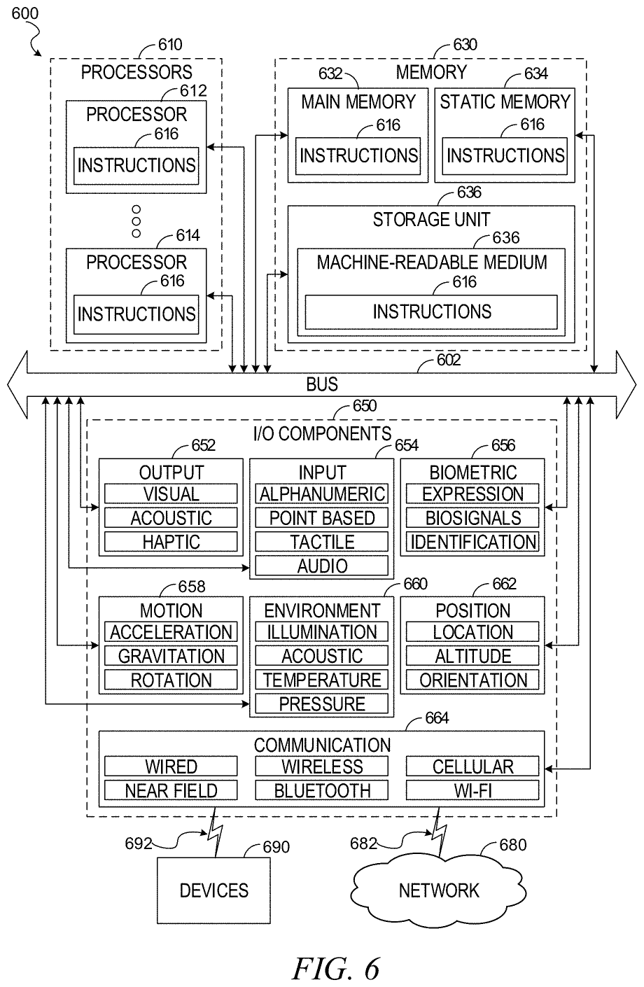

FIG. 5 is a block diagram 500 illustrating a software architecture 502, which can be installed on any one or more of the devices described above. FIG. 5 is merely a non-limiting example of a software architecture, and it will be appreciated that many other architectures can be implemented to facilitate the functionality described herein. In various embodiments, the software architecture 502 is implemented by hardware such as a machine 600 of FIG. 6 that includes processors 610, memory 630, and input/output (I/O) components 650. In this example architecture, the software architecture 502 can be conceptualized as a stack of layers where each layer may provide a particular functionality. For example, the software architecture 502 includes layers such as an operating system 504, libraries 506, frameworks 508, and applications 510. Operationally, the applications 510 invoke API calls 512 through the software stack and receive messages 514 in response to the API calls 512, consistent with some embodiments.

In various implementations, the operating system 504 manages hardware resources and provides common services. The operating system 504 includes, for example, a kernel 520, services 522, and drivers 524. The kernel 520 acts as an abstraction layer between the hardware and the other software layers, consistent with some embodiments. For example, the kernel 520 provides memory management, processor management (e.g., scheduling), component management, networking, and security settings, among other functionality. The services 522 can provide other common services for the other software layers. The drivers 524 are responsible for controlling or interfacing with the underlying hardware, according to some embodiments. For instance, the drivers 524 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 506 provide a low-level common infrastructure utilized by the applications 510. The libraries 506 can include system libraries 530 (e.g., C standard library) that can provide functions such as memory allocation functions, string manipulation functions, mathematic functions, and the like. In addition, the libraries 506 can include API libraries 532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 506 can also include a wide variety of other libraries 534 to provide many other APIs to the applications 510.

The frameworks 508 provide a high-level common infrastructure that can be utilized by the applications 510, according to some embodiments. For example, the frameworks 508 provide various graphical user interface functions, high-level resource management, high-level location services, and so forth. The frameworks 508 can provide a broad spectrum of other APIs that can be utilized by the applications 510, some of which may be specific to a particular operating system 504 or platform.

In an example embodiment, the applications 510 include a home application 550, a contacts application 552, a browser application 554, a book reader application 556, a location application 558, a media application 560, a messaging application 562, a game application 564, and a broad assortment of other applications, such as a third-party application 566. According to some embodiments, the applications 510 are programs that execute functions defined in the programs. Various programming languages can be employed to create one or more of the applications 510, structured in a variety of manners, such as object-oriented programming languages (e.g., Objective-C, Java, or C++) or procedural programming languages (e.g., C or assembly language). In a specific example, the third-party application 566 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 566 can invoke the API calls 512 provided by the operating system 504 to facilitate functionality described herein.

FIG. 6 illustrates a diagrammatic representation of a machine 600 in the form of a computer system within which a set of instructions may be executed for causing the machine 600 to perform any one or more of the methodologies discussed herein, according to an example embodiment. Specifically, FIG. 6 shows a diagrammatic representation of the machine 600 in the example form of a computer system, within which instructions 616 (e.g., software, a program, an application 510, an applet, an app, or other executable code) for causing the machine 600 to perform any one or more of the methodologies discussed herein may be executed. For example, the instructions 616 may cause the machine 600 to execute the method 400 of FIG. 4. Additionally, or alternatively, the instructions 616 may implement FIGS. 1-4, and so forth. The instructions 616 transform the general, non-programmed machine 600 into a particular machine 600 programmed to carry out the described and illustrated functions in the manner described. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 616, sequentially or otherwise, that specify actions to be taken by the machine 600. Further, while only a single machine 600 is illustrated, the term “machine” shall also be taken to include a collection of machines 600 that individually or jointly execute the instructions 616 to perform any one or more of the methodologies discussed herein.

The machine 600 may include processors 610, memory 630, and I/O components 650, which may be configured to communicate with each other such as via a bus 602. In an example embodiment, the processors 610 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 612 and a processor 614 that may execute the instructions 616. The term “processor” is intended to include multi-core processors 610 that may comprise two or more independent processors 612 (sometimes referred to as “cores”) that may execute instructions 616 contemporaneously. Although FIG. 6 shows multiple processors 610, the machine 600 may include a single processor 612 with a single core, a single processor 612 with multiple cores (e.g., a multi-core processor), multiple processors 610 with a single core, multiple processors 610 with multiple cores, or any combination thereof.

The memory 630 may include a main memory 632, a static memory 634, and a storage unit 636, all accessible to the processors 610 such as via the bus 602. The main memory 632, the static memory 634, and the storage unit 636 store the instructions 616 embodying any one or more of the methodologies or functions described herein. The instructions 616 may also reside, completely or partially, within the main memory 632, within the static memory 634, within the storage unit 636, within at least one of the processors 610 (e.g., within the processor's cache memory), or any suitable combination thereof, during execution thereof by the machine 600.

The I/O components 650 may include a wide variety of components to receive input, provide output, produce output, transmit information, exchange information, capture measurements, and so on. The specific I/O components 650 that are included in a particular machine 600 will depend on the type of machine 600. For example, portable machines such as mobile phones will likely include a touch input device or other such input mechanisms, while a headless server machine will likely not include such a touch input device. It will be appreciated that the I/O components 650 may include many other components that are not shown in FIG. 6. The I/O components 650 are grouped according to functionality merely for simplifying the following discussion, and the grouping is in no way limiting. In various example embodiments, the I/O components 650 may include output components 652 and input components 654. The output components 652 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 650 may include biometric components 656, motion components 658, environmental components 660, or position components 662, among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 662 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 or devices 690 via a coupling 682 and a coupling 692, respectively. For example, the communication components 664 may include a network interface component or another suitable device to interface with the network 680. In further examples, the communication components 664 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 670 may be another machine or any of a wide variety of peripheral devices (e.g., a peripheral device coupled via a USB).

Moreover, the communication components 664 may detect identifiers or include components operable to detect identifiers. For example, the communication components 664 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 664, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 630, 632, 634, and/or memory of the processor(s) 610) and/or the storage unit 636 may store one or more sets of instructions 616 and data structures (e.g., software) embodying or utilized by any one or more of the methodologies or functions described herein. These instructions (e.g., the instructions 616), when executed by the processor(s) 610, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 616 and/or data. The terms shall accordingly be taken to include, but not be limited to, solid-state memories, and optical and magnetic media, including memory internal or external to the processors 610. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 680 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 680 or a portion of the network 680 may include a wireless or cellular network, and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 616 may be transmitted or received over the network 680 using a transmission medium via a network interface device (e.g., a network interface component included in the communication components 664) and utilizing any one of a number of well-known transfer protocols (e.g., HTTP). Similarly, the instructions 616 may be transmitted or received using a transmission medium via the coupling 672 (e.g., a peer-to-peer coupling) to the devices 670. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 616 for execution by the machine 600, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a non-transitory computer-readable medium having instructions stored thereon, which, when executed by a processor, cause the system to perform operations comprising:
obtaining a first training set of one or more data items having information about whether a first event occurred and information about whether a second event dependent on the first event occurred;
using the first training set as input to a first machine learning algorithm to train a first model to predict whether the second event will occur for a data item passed as input to the first model;
obtaining a second training set of one or more data items having information about whether the first event occurred but not having data about whether the second event occurred;
inputting the data items in the second training set to the first model to obtain one or more predictions as to whether the second event will occur;
adding the predictions as labels to the second training set; and
using the second training set as input to a second machine learning algorithm to train a second model to predict whether the second event will occur for a data item passed as input to the second model.

2. The system of claim 1, wherein the second event is a confirmed hire for a job and the first event is an application for the job.

3. The system of claim 2, wherein the first training set includes data about users that were hired for jobs that they applied to using a graphical user interface of a social networking service.

4. The system of claim 2, wherein the second training set includes data about users who applied for jobs using a graphical user interface of a social networking service.

5. The system of claim 1, wherein the second training set includes a first portion of one or more data items in which the first event is known to have occurred and a second portion of one or more data items in which the second event is known to have not occurred; and
wherein the inputting and adding is only performed for data items in the first portion and not for data items in the second portion.

6. The system of claim 5, wherein the operations further comprise automatically adding negative labels for data items in the second portion of one or more data items.

7. The system of claim 1, wherein the first machine learning algorithm is a different machine learning algorithm than the second machine learning algorithm.

8. The system of claim 7, wherein the first machine learning algorithm is a pointwise deep learning neural network.

9. The system of claim 8, wherein the second machine learning algorithm is a listwise deep learning neural network.

10. The system of claim 1, wherein the second event is a purchase of a good or service and the first event is the clicking of an advertisement for the purchase of the good or service.

11. The system of claim 1, wherein the operations further comprise: obtaining information about a first user and a first item being considered for display to the first user; and
passing the information about the first user and first item to the second model, to predict a likelihood of the first event occurring if the first item is displayed to the first user.

12. A method comprising:
obtaining a first training set of one or more data items having information about whether a first event occurred and information about whether a second event dependent on the first event occurred;
using the first training set as input to a first machine learning algorithm to train a first model to predict whether the second event will occur for a data item passed as input to the first model;
obtaining a second training set of one or more data items having information about whether the first event occurred but not having data about whether the second event occurred;
inputting the data items in the second training set to the first model to obtain one or more predictions as to whether the second event will occur;
adding the predictions as labels to the second training set; and
using the second training set as input to a second machine learning algorithm to train a second model to predict whether the second event will occur for a data item passed as input to the second model.

13. The method of claim 12, wherein the second event is a confirmed hire for a job and the first event is an application for the job.

14. The method of claim 13, wherein the first training set includes data about users that were hired for jobs that they applied to using a graphical user interface of a social networking service.

15. The method of claim 13, wherein the second training set includes data about users who applied for jobs using a graphical user interface of a social networking service.

16. The method of claim 12, wherein the second training set includes a first portion of one or more data items in which the first event is known to have occurred and a second portion of one or more data items in which the first event is known to have not occurred; and
wherein the inputting and adding is only performed for data items in the first portion and not for data items in the second portion.

17. The method of claim 16, wherein the operations further comprise automatically adding negative labels for data items in the second portion of one or more data items.

18. The method of claim 12, wherein the first machine learning algorithm is a different machine learning algorithm than the second machine learning algorithm.

19. The method of claim 18, wherein the first machine learning algorithm is a pointwise deep learning neural network.

20. A system comprising:
means for obtaining a first training set of one or more data items having information about whether a first event occurred and information about whether a second event dependent on the first event occurred;
means for using the first training set as input to a first machine learning algorithm to train a first model to predict whether the second event will occur for a data item passed as input to the first model; means for obtaining a second training set of one or more data items having information about whether the first event occurred but not having data about whether the second event occurred;
means for inputting the data items in the second training set to the first model to obtain one or more predictions as to whether the second event will occur;
means for adding the predictions as labels to the second training set; and
means for using the second training set as input to a second machine learning algorithm to train a second model to predict whether the second event will occur for a data item passed as input to the second model.
